(19) United States
(12) Patent Application Publication
(10) Pub. No.: US 2006/0279958 A1
(43) Pub. Date: Dec. 14, 2006

(54) Apparatus and method for providing attachment of magnetic devices in a decorative lighting system

(76) Inventors: James Cline, Granbury, TX (US); Christopher Giblin, Grapevine, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/151,366

(22) Filed: Jun. 13, 2005

(51) Int. Cl. F21V 21/00

(52) U.S. Cl. 362/398

(57) ABSTRACT

An apparatus and method is disclosed for providing the attachment of a plurality of magnetic devices for use in a decorative lighting system. The magnetic device comprises a magnetic base assembly, coupled with a magnet recessed into a first side of the magnetic base assembly, a supporting element, coupled to a second side of the magnetic base assembly, a first interior element parallel with a second interior element extending from the exterior top portion of the supporting element to a circular element in the interior bottom portion of the supporting element.

### TECHNICAL FIELD OF THE INVENTION

The present invention relates generally to decorative lighting systems and, more specifically, to an apparatus and method for providing the attachment of a plurality of magnetic devices for use in a decorative lighting system.

### BACKGROUND OF THE INVENTION

The world has seen an explosion of growth in the use of decorations in the celebration of various holidays. The use of decorative lighting illuminates the homes of many neighborhoods during the holiday season and in particular at Christmas time.

Each year both business and households from around the world set out to “out do” their prior decorative displays in hope of spreading the holiday cheer throughout their business district or neighborhoods. The decorative lighting typically comprises an electrical plug or other electrical source, a length of wire comprising a plurality of light sockets and light bulbs that are dispersed at various intervals throughout the length of the wire.

Conventional methods to attach the decorative lighting for display is to intrusively attach nails, hooks, staples, or other forms of connecting apparatus into the structure of the business or home. This not only unsightly as it leaves the nails, hooks, and staples protruding from the structure during non decorative lighting display times, but it is also ineffective when dealing with metal structures such as a roof, drip edge, trim, fencing, door or the like.

Accordingly there is a need in the art for providing an apparatus and method for providing the attachment of a plurality of magnetic devices for use in a decorative lighting system. There is also a need to provide a method for providing a plurality of magnetic base assembly's capable of attaching, to at least one portion of a magnetic decorative lighting system. cl SUMMARY OF THE INVENTION

It is an object of the present invention to overcome the above-discussed deficiencies of the prior art, and more specifically it is a primary object of the present invention to provide an apparatus and method for providing the attachment of a plurality of magnetic devices for use in a decorative lighting system.

The present invention provides a magnetic device capable of attaching to at least one light socket in a decorative lighting system. According to an advantageous embodiment of the present invention, the magnetic device comprises a magnetic base assembly coupled with a magnet recessed into a first side of the magnetic base assembly and a supporting element coupled to a second side of the magnetic base assembly.

According to one embodiment of the present invention, the supporting element further comprises a first interior element parallel with a second interior element extending from the exterior top portion of the supporting element to a circular element in the interior bottom portion of the supporting element.

According to another embodiment of the present invention, the magnetic device may comprise a directional element coupled with the magnetic base assembly and the supporting element to provide a 0 to 270 degree angle of the supporting element relative to the magnetic base assembly.

It is still another object of the present invention to provide a magnetic decorative lighting system comprising a plurality of magnetic base assembly's capable of attaching to at least one portion of the magnetic decorative lighting system. According to an advantageous embodiment of the present invention, at least one of the plurality of magnetic base assembly's comprises a magnet recessed into a first side of the plurality of magnetic base assembly's and a second side of the plurality of magnetic base assembly's capable of coupling to at least one portion of the magnetic decorative lighting system.

According to yet another embodiment of the present invention, the plurality of magnetic base assembly's are capable of coupling to at least one portion of the wire or the light sockets of the magnetic decorative lighting system.

According to still another embodiment of the present invention a method for providing a plurality of magnetic base assembly's capable of attaching to at least one portion of the magnetic decorative lighting system. According to an advantageous embodiment of the present invention, the method includes recessing a magnet into a first side of the plurality of magnetic base assembly's and coupling a second side of the plurality of magnetic base assembly's to at least one portion of the magnetic decorative lighting system.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### BRIEF DESCRIPTION OF THE DRAWINGS

A more complete understanding of the present invention, its preferred embodiments, further objects, and advantages thereof, will become more apparent by reference to the following detailed description taken in conjunction with the accompanying drawings, wherein like reference numbers indicate like elements, and in which:

FIGS. 1A and 1B illustrate an exemplary magnetic device, in accordance with an exemplary embodiment of the present invention;

FIGS. 2A and 2B illustrate an exemplary magnetic device, in accordance with an advantageous embodiment of the present invention;

FIG. 3 illustrates selected portions of an exemplary magnetic decorative lighting system according to the principles of the present invention; and

FIG. 4 is a high-level flow diagram illustrating a method for providing attachment of magnetic devices in an exemplary magnetic decorative lighting system, in accordance with the principles of the present invention.

### DETAILED DESCRIPTION OF THE INVENTION

Reference will now be made to the following detailed description of the exemplary embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

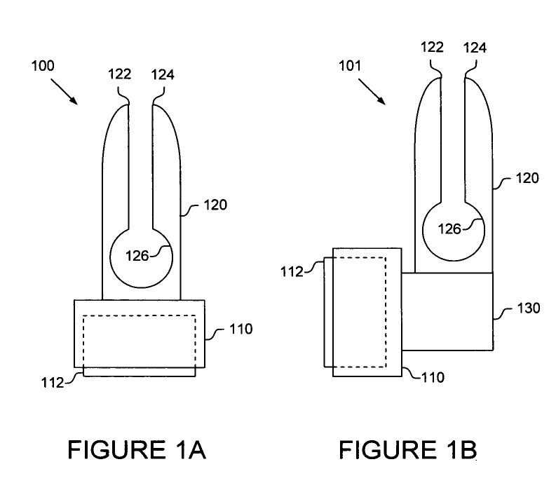

FIG. 1A illustrates exemplary magnetic device 100 according to an exemplary embodiment of the present invention. Magnetic device 100 comprises magnetic base assembly 110 coupled to supporting element 120. Magnetic base assembly 110 comprises magnet 112 recessed into a first side of magnetic base assembly 110 and supporting element 120 coupled to a second side of magnetic base assembly 110. Supporting element 120 comprises a first interior element 122 parallel with a second interior element 124 extending from the exterior top portion of supporting element 120 to circular element 126 in the interior bottom portion of supporting element 120.

In one embodiment of the present invention magnetic base assembly 110 is capable of being magnetically coupled and uncoupled to metal surfaces. Magnets and the application of affixing materials to magnets, such as magnetic base assembly 110 and magnet 112, are well known in the art and are not discussed further. Although, magnetic base assembly 110 and magnet 112 are shown as an idealized fitting component. Those skilled in the art will recognize that this is given by way of example and that the present invention is not limited to such an idealized fitting component, for example magnet 112 may be substantially larger or smaller, of a different shape, such as square or hexagon, then shown in FIG. 1.

According to an exemplary embodiment of the present invention, supporting element 120 is capable of receiving lights, cords, wires and the like. To further explain the function of supporting element 120, an example is now given. In the following example, a typical decorative lighting system comprising a length of wire and a plurality of light sockets. A first light socket of the decorative lighting system is placed between first interior element 122 and second interior element 124 and secured into circular element 126 in the interior bottom portion of supporting element 120. Accordingly, magnetic device 100 is fixedly coupled with the first light socket of the decorative lighting system.

Next, a second light socket of the decorative lighting system is fixedly coupled to a second magnetic device 100 and so on until all light sockets of the decorative lighting system are fixedly coupled with magnetic device 100. As a result, magnetic device 100 is provided to magnetically couple and uncouple to metal structures such as a roof, drip edge, trim, fencing, doors and the like.

FIG. 1B illustrates exemplary magnetic device 101 according to an exemplary embodiment of the present invention. Magnetic device 101 comprises magnetic base assembly 110, supporting element 120, and directional element 130. As described above, magnetic base assembly 110 comprises magnet 112. Magnetic base assembly 110 also comprises directional element 130 coupled to a second side of magnetic base assembly 110. Directional element 130 comprises supporting element 120 coupled at a 90 degree angle relative to the second side of magnetic base assembly 110. As described above, supporting element 120 comprises a first interior element 122, a second interior element 124 and a circular element 126.

It is understood that magnetic device 101 is given by way of example and that, for simplicity and clarity, only so much of the construction and operation of magnetic device 101 as is unique to the present invention or necessary for an understanding of the present invention is shown and described. Moreover, although directional element 130 is shown in FIG. 1A as employed in a 90 degree fixed relationship to magnetic base assembly 110. Those skilled in the art will recognize that the functionality described herein may be readily adapted to other types of fixed or rotational angles such as 0 to 270 degrees. In an alternate embodiment (not shown) directional element 130 may provide any number of fixed angles such as, 10 degrees, 45 degrees, 245 degrees or the like. In an alternate exemplary embodiment (not shown) directional element 130 may provide a rotational element that allows manual articulation of 0 to 270 degrees.

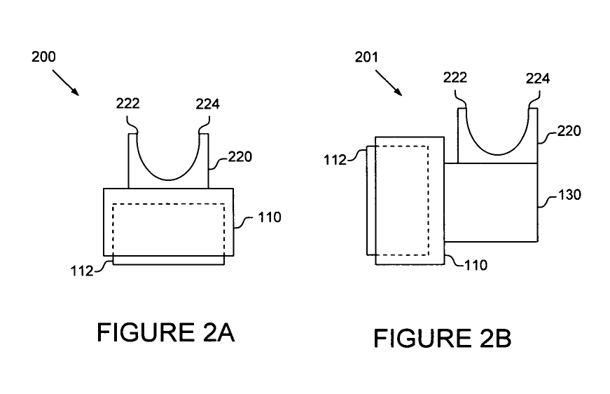

FIG. 2A illustrates exemplary magnetic device 200 according to an advantageous embodiment of the present invention. Magnetic device 200 comprises magnetic base assembly 110 coupled to supporting element 220. As described above in FIG. 1, magnetic base assembly 110 comprises magnet 112. Magnetic base assembly 110 further comprises supporting element 220 coupled to a second side of magnetic base assembly 110. Supporting element 220 comprises a first interior element 222 and a second interior element 224 extending from the exterior top portion of supporting element 120 in a circular direction to the interior bottom portion of supporting element 220.

FIG. 2B illustrates exemplary magnetic device 201 according to an advantageous embodiment of the present invention. Magnetic device 201 comprises magnetic base assembly 110, directional element 130, and supporting element 220. As described above in FIG. 1, magnetic base assembly 110 comprises magnet 112. Magnetic base assembly 110 also comprises directional element 130 coupled to a second side of magnetic base assembly 110. Directional element 130 comprises supporting element 220 coupled at a 90 degree angle relative the second side of magnetic base assembly 110. As described above, supporting element 220 comprises a first interior element 222, a second interior element 224 extending in a circular direction to the interior bottom portion of supporting element 220.

The embodiments of the present invention shown and described in FIGS. 1A, 1B, 2A and 2B provide for the attachment of a decorative lighting system. However, it should be understood that the present invention is not limited to the use of a decorative lighting system and may be utilized in a manner described in further detail below. Those skilled in the art will recognize that the functionality described herein may be readily employed through other types of attachments. For example, magnetic device 100, 101, 200, or 201 may be used to support large decorative accessories and components such as sleighs, reindeer, Santa, extension cords and the like.

In an alternative advantageous embodiment of the present invention, a magnetic converter device (not shown) may be used in conjunction with exemplary magnetic device 100, 101, 200, or 201. This will allow the magnetic device to be used where no metal is available for magnetic coupling and uncoupling. For example, the magnetic converter device may comprise a flat metal surface for magnetically coupling and uncoupling the magnetic device on a first side and a converting element coupled to a second side of magnetic converter device. For example, the converting element may comprise a screw, nail, or the like.

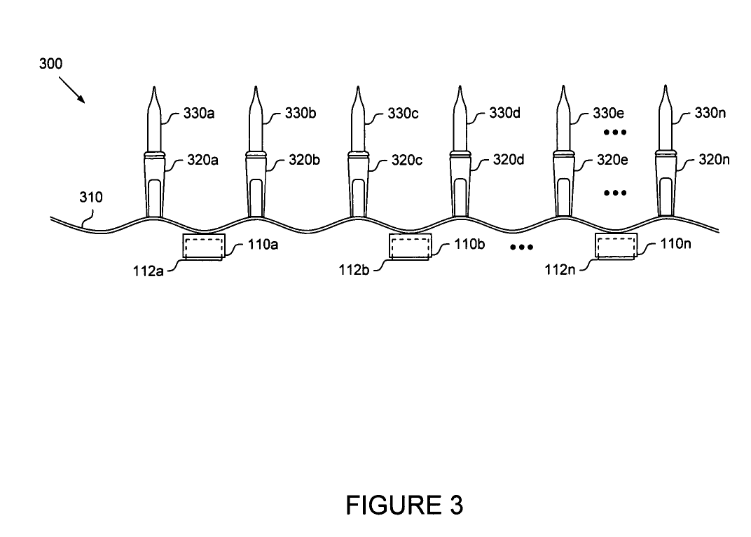

FIG. 3 illustrates selected portions of exemplary magnetic decorative lighting system 300 according to the principles of the present invention. Magnetic decorative lighting system 300 comprises magnetic base assembly's 110a, 110b, through 110n, wire 310, light sockets 320a, 320b, 320c, 320d, 320e, through 320n and light bulbs 330a, 330b, 330c, 330d, 330e, through 330n. As described above in FIG. 1, magnetic base assembly's 110a-110n comprise magnets 112a-112n. Light sockets 320a-320n comprise light bulbs 330a-330n and are well known in the art and are not discussed further.

For simplicity and clarity, only a single wire 310 is shown coupled to a single one of light sockets 330a-330n, as is unique to the present invention or necessary for an understanding of the present invention. Those skilled in the art will understand that the interconnection of wire 310 and light sockets 330a-330n are given by way of example and should not be construed to limit the scope of the present invention. In one embodiment (not shown), magnetic decorative lighting system 300 comprises a first end comprising a male electrical adapter capable of receiving electricity, a second end comprising a female electrical adapter capable of allowing electricity to flow to a subsequent magnetic decorative lighting system, a plurality of wires that interconnect with a plurality of light sockets to form a proper electrical connection in accordance with conventional practices.

In one embodiment of the present invention, magnetic base assembly 110a is coupled to wire 310 between light socket 320a and light socket 320b, magnetic base assembly 110b is coupled to wire 310 between light socket 320c and light socket 320d, and magnetic base assembly 110n is coupled to wire 310 between light socket 320e and light socket 320n. In essence, magnetic base assembly's 110a-110n are coupled to wire 310 after every third light socket. Alternatively, magnetic base assembly's 110a-110n may be coupled to wire 310 after every first, second, fourth, fifth, or sixth light socket 320a-320n.

In one advantageous embodiment of the present invention, magnetic base assembly 110a is capable of being coupled to light socket 320a, magnetic base assembly 110b is capable of being coupled to light socket 320c, and magnetic base assembly 110n is capable of being coupled to light socket 320n. In essence, magnetic base assembly's 110a-110n are coupled to every third light socket. Alternatively, magnetic base assembly's 110a-110n may be coupled to every first, second, fourth, fifth, or sixth light socket 320a-320n.

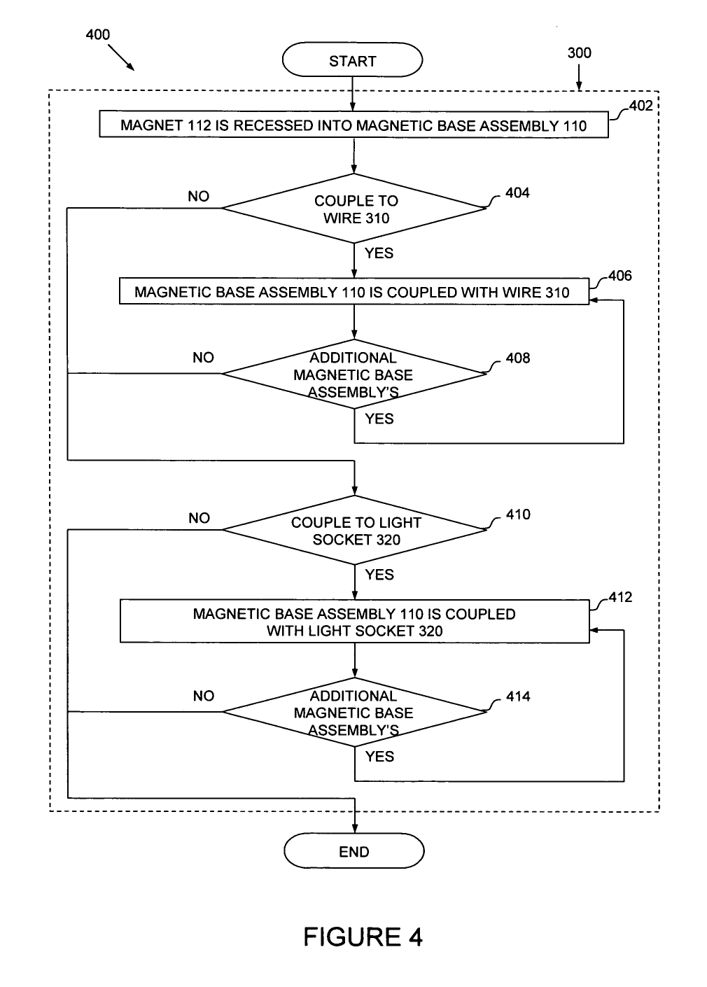

FIG. 4 illustrates a high-level flow diagram 400, of a method for providing a plurality of magnetic base assembly 320a-320n capable of attaching, to at least one portion of magnetic decorative lighting system 300 in accordance with the principles of the present invention. It is recalled from the above description, that, magnetic decorative lighting system 300 comprises magnetic base assembly's 110a-110n, magnets 112a-112n, wire 310, light sockets 320a-320n and light bulbs 330a-330n. For this embodiment only a single magnetic base assembly 110, a single magnet 112 and a single light socket 320 are described, as is unique to the present invention or necessary for an understanding of the method for providing a magnetic base assembly capable of attaching, to at least one portion of magnetic decorative lighting system 300.

Magnet 112 is recessed into a first side of magnetic base assembly 110 (process step 402). If the second side of magnetic base assembly 110 is to be coupled to at least one portion of wire 310 of magnetic decorative lighting system 300 then proceed to process step 406 (process step 404).

The second side of magnetic base assembly 110 is coupled to at least one portion of wire 310 (process step 406). If additional magnetic base assembly's 110 are to be coupled to wire 310 of magnetic decorative lighting system 300 process step 406 is repeated until all magnetic base assembly's 110 are coupled to wire 310 of magnetic decorative lighting system 300 (process steps 406 and 408).

If the second side of magnetic base assembly 110 is not to be coupled with wire 310 or there are no additional magnetic base assembly's 110 to couple to wire 310 of magnetic decorative lighting system 300, proceed to step 410 (process steps 404 and 408). If the second side of magnetic base assembly 110 is to be coupled to at least one portion of light socket 320 of magnetic decorative lighting system 300 then proceed to process step 412 (process step 410).

The second side of magnetic base assembly 110 is coupled to at least one portion of light socket 320 (process step 412). If additional magnetic base assembly's 110 are to be coupled to light socket 320 of magnetic decorative lighting system 300 process step 412 is repeated until all magnetic base assembly's 110 are coupled to light sockets 320 of magnetic decorative lighting system 300 (process steps 412 and 414).

If there are no additional magnetic base assembly's 110 to couple with wire 310 or there are no additional magnetic base assembly's 110 to couple to light socket 320 of magnetic decorative lighting system 300, the process end's (process steps 410 and 414).

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. For use in a decorative lighting system, a magnetic device capable of attaching to at least one portion of a decorative lighting system, said magnetic device comprising:
a magnetic base assembly, coupled with a magnet recessed into a first side of said magnetic base assembly; and
a supporting element, coupled to a second side of said magnetic base assembly.

2. The magnetic device set forth in claim 1 wherein said magnet device is capable of magnetically coupling and uncoupling to a metal surface.

3. The magnetic device set forth in claim 2 wherein said supporting element further comprises:
a first interior element parallel with a second interior element extending from the exterior top portion of said supporting element to a circular element in the interior bottom portion of said supporting element.

4. The magnetic device set forth in claim 2 wherein said supporting element further comprises:
a first interior element and a second interior element extending from the exterior top portion of said supporting element in a circular direction to the interior bottom portion of said supporting element.

5. The magnetic device set forth in claim 2 further comprising a directional element coupled on a first side with said magnetic base assembly and on a second side with said supporting element.

6. The magnetic device set forth in claim 5 wherein said supporting element is capable of a fixed angel between 0 and 270 degrees relative to said magnetic base assembly.

7. The magnetic device set forth in claim 5 wherein said supporting element is capable of manual adjustment from a 0 to 270 degree angle relative to said magnetic base assembly.

8. The magnetic device set forth in claim 2 wherein said metal surface is a magnetic converter device comprising:
a flat metal surface on a first side and a converting element coupled to a second side of said magnetic converter device.

9. The magnetic device set forth in claim 8 wherein said converting element is a nail.

10. A magnetic decorative lighting system comprising a plurality of magnetic base assembly's capable of attaching to at least one portion of said magnetic decorative lighting system, at least one of said plurality of magnetic base assembly's comprising:
a magnet recessed into a first side of said plurality of magnetic base assembly's; and
a second side of said plurality of magnetic base assembly's capable of coupling to at least one portion of said magnetic decorative lighting system.

11. The magnetic decorative lighting system set forth in claim 10 wherein said plurality of magnetic base assembly's is capable of magnetically coupling and uncoupling to a metal surface.

12. The magnetic decorative lighting system set forth in claim 11 further comprising at least one wire capable of electrically coupling to at least one light socket.

13. The magnetic decorative lighting system set forth in claim 12 wherein said plurality of magnetic base assembly's is coupled with at least one portion of said wire.

14. The magnetic decorative lighting system set forth in claim 12 wherein said plurality of magnetic base assembly's is coupled with at least one light socket.

15. The magnetic decorative lighting system set forth in claim 13 further comprising a plurality of magnetic base assembly's coupled to said wire after every one of said light sockets.

16. The magnetic decorative lighting system set forth in claim 14 further comprising a plurality of magnetic base assembly's coupled to every one of said light sockets.

17. For use in a magnetic decorative lighting system, a method for providing a plurality of magnetic base assembly's capable of attaching to at least one portion of said magnetic decorative lighting system, the method comprising the steps of:
recessing a magnet into a first side of said plurality of magnetic base assembly's; and
coupling a second side of said plurality of magnetic base assembly's to at least one portion of said magnetic decorative lighting system.

18. The method as set forth in claim 17 wherein said plurality of magnetic base assembly's comprises properties associated with magnetically coupling and uncoupling to a metal surface.

19. The method as set forth in claim 18 wherein said plurality of magnetic base assembly's is coupled to at least one portion of a wire of said magnetic decorative lighting system.

20. The method as set forth in claim 18 wherein said plurality of magnetic base assembly's is coupled to at least one portion of a light socket of said magnetic decorative lighting system.
